(19) United States
(12) Patent Application Publication
(10) Pub. No.: US 2019/0084728 A1
(43) Pub. Date: Mar. 21, 2019

(54) TAMPER EVIDENCE DEVICE FOR ROLL-ON PILFER PROOF CLOSURES

(71) Applicant: BALL CORPORATION, Broomfield, CO (US)

(72) Inventors: David J. Bonfoey, Broomfield, CO (US); John R. Ross, Broomfield, CO (US)

(73) Assignee: BALL CORPORATION, Broomfield, CO (US)

(21) Appl. No.: 16/110,598

(22) Filed: Aug. 23, 2018

Related U.S. Application Data
(60) Provisional application No. 62/559,893, filed on Sep. 18, 2017.

(51) Int. Cl. B65D 41/34; B67B 3/18; B65D 1/02

(52) U.S. Cl. CPC B65D 41/3438; B65D 1/0246; B65D 41/3447; B67B 3/18

(57) ABSTRACT

Methods and apparatus of sealing bottles with Roll-on Pilfer Proof (ROPP) closures and providing tamper evidence are provided. More specifically, the present invention relates to novel ROPP closures that may be used to seal a bottle shaped container which can subsequently receive a tamper evidence device. The bottle can have a neck portion formed without a skirt portion. Optionally, the bottle can include an annular ring. The ROPP closure generally includes a body portion. In one embodiment, the body portion has a curl. A tamper evidence device can be applied to a bottle sealed with a ROPP closure by a capping apparatus. The tamper evidence device may be visually altered when the ROPP closure is rotated in an opening direction. In one embodiment, the ROPP closure cannot be rotated while the tamper evidence device is associated with the bottle. In another embodiment, the tamper evidence device includes at least one protrusion which extends inwardly at least partially into the bottle annular ring.

### CROSS-REFERENCE TO RELATED APPLICATIONS

This application claims priority under 35 U.S.C. § 119(e) to U.S. Provisional Patent Application Ser. No. 62/559,893 filed Sep. 18, 2017 and entitled “Tamper Evidence Device for Roll-On Pilfer Proof Closures,” which is incorporated herein in its entirety by reference.

### FIELD OF THE INVENTION

The present invention relates generally to the manufacture and sealing of containers. More specifically, this invention provides tamper evidence devices for use with bottles sealed by Roll-on Pilfer Proof (ROPP) closures.

### BACKGROUND

Modern containers are used to store a variety of products including beverages and food products. Containers have a variety of shapes depending on the application. Some containers, such as beverage containers, have a bottle shape. Bottle shaped containers typically include a closed bottom portion, a generally cylindrical body portion, a neck portion with a reduced diameter extending upwardly from the body portion, and an opening positioned on an uppermost portion of the neck portion opposite to the closed bottom portion. Bottles may be formed from a variety of materials, including plastic, glass, and more commonly metal (including tin coated steel and aluminum). Methods and apparatus of forming a threaded neck to receive a ROPP closure on a bottle formed of metal are generally described in U.S. Patent Application Publication No. 2014/0263150 which is incorporated herein by reference in its entirety.

After being filled with a beverage or other product, bottles are typically sealed with a ROPP that may be used to re-close the bottle. ROPP closures frequently include a tamper indicator or pilfer band releasably interconnected to a body of the ROPP closure. The pilfer band is adapted to separate from the closure body when the ROPP closure is at least partially rotated in an opening direction. When the ROPP closure is removed from the bottle, the pilfer band is retained on the neck of the bottle. In this manner, the pilfer band provides a visual indicator to the consumer that the bottle has been at least partially opened or that someone has tampered with the bottle.

Referring now to FIGS. 1A-1F, several prior art steps are depicted during capping of a prior art bottle 2 to generate and maintain an effective seal between the bottle 2 and a prior art ROPP closure 10. As shown in FIGS. 1A-1B, a ROPP shell 9 with an unthreaded body portion 12A is placed on the neck portion 4 of the bottle 2. A bottom portion of the ROPP shell 9 forms a pilfer band 18 that is releasably interconnected to the ROPP shell 9 by a serrated band 17. The ROPP shell 9 covers the bottle threads 8 with the pilfer band 18 extending downward past a skirt 30 of the bottle 2.

Referring now to FIG. 1C, a capping apparatus 22 subsequently performs three operations, including: (1) reforming the top portion 20 of the ROPP closure 10 to form a reform or channel 32; (2) forming threads 16 on a portion of the closure body 12; and (3) tucking the pilfer band 18 against the skirt 30 of the bottle 2. The timing and sequence of these three actions varies between different prior art capping apparatus 22. Generally, one or more of a pressure block ejector 24 and a pressure block 25 apply a load, or “top load,” to a top portion 20 of the ROPP closure 10 to press an outer edge of the top portion 20 down around a curl 6 of the bottle 2 creating a reform or channel 32 in the ROPP closure. An interior surface of the channel 32 applies force to a liner 14 within the ROPP closure 10. Accordingly, the liner 14 contacts an exterior of the bottle curl 6 to form an effective seal.

Once sealed, closure threads 16 are formed on the ROPP closure 10 to maintain the seal once the pressure block ejector 24 and the pressure block 25 are removed. The closure threads 16 are formed by a thread roller 26 that applies a “sideload” to the closure body 12. Typically, two thread rollers 26 are used. The thread rollers 26 use the underlying bottle threads 8 as a mandrel. The closure threads 16 are formed as the thread rollers 26 press against and chase down the body portion 12 along the bottle threads 8.

Two pilfer rollers 28 press inwardly against the bottle 2 to tuck the bottom edge of the ROPP closure 10 against a protrusion, known as the skirt 30, of the bottle 2. The pilfer rollers 28 also apply a sideload to the bottle 2 to tuck the pilfer band 18 against the bottle skirt 30. Some pilfer rollers 28 contact a portion of the bottle 2 while tucking the pilfer band 18. The pilfer band 18 is typically rolled inwardly at an angle of about 45° on the bottle 2. In this manner, if the ROPP closure 10 is rotated in an opening direction, the serrated band 17 is severed and the pilfer band 18 is retained on the bottle neck portion 4 to provide visual evidence of tampering. For most bottles 2, the bottle threads 8 are configured such that the opening direction of the ROPP closure 10 is counter-clockwise.

An example of a neck portion 4 of a metallic bottle 2 sealed by a ROPP closure 10 is illustrated in FIG. 1D. An expanded view of a portion of another embodiment of a prior art metallic bottle 2 is illustrated in FIG. 1E. The metallic bottle 2 is also shown sealed by another prior art ROPP closure 10 in FIG. 1F.

There are several problems associated with current ROPP closures 10 as well as the methods and apparatus used to seal them to a bottle 2. To open a bottle sealed with a prior art ROPP closure 10 which includes a pilfer band 18, a consumer must rotate the closure in an opening direction with sufficient torque to sever the serrated band 17. Rotating the closure with the sufficient torque can be a challenge to some consumers.

Another deficiency is that the bottom edge 19 of the pilfer band 18 (which is retained on the neck portion 4) may flare outwardly once the ROPP closure 10 is removed from the bottle 2. The bottom edge 19 may be sharp such that the outward flare of the pilfer band 18 generates a cutting hazard. Further, when the serrated band 17 is severed, the pilfer band 18 may slide downwardly away from the bottle skirt 30 such that the edge of the pilfer band 18 proximate to the serrated band 17 is exposed, creating another potential cutting hazard.

An additional problem with prior art ROPP closures and capping apparatus 22 are the large forces generated by the capping apparatus 22. When a bottle 2 is sealed with a ROPP closure 10, a pilfer roller 28 must push against the bottle 2 to tuck the pilfer band 18 against a skirt 30 of the bottle. This force must be accounted for when forming the bottle 2, such as by strengthening the bottle 2 to withstand the force from the pilfer roller 28. This frequently results in forming the bottle of a thicker material than would be required by a similar bottle 2 that does not have to withstand the sideload force of the pilfer rollers 28.

Metallic bottles 2 formed of aluminum may be sealed with ROPP closures 10 by a capping apparatus 22 that applies a cumulative load of up to about 380 pounds force. Although less than the cumulative load applied to glass bottles sealed with ROPP closures, these loads are almost excessive for current metallic bottles 2. Accordingly, there is only a small production window that is useful for capping metallic bottles 2 with prior art ROPP closures 10 and methods. The small production window results in overstress and failures of the metallic bottle 2 or the ROPP closure 10 when the capping apparatus 22 is out of calibration or for marginal metallic bottles 2. Further, because the nominal load applied by the prior art processes and capping apparatus 22 are close to the maximum amount that the metallic bottle 2 can withstand without failing, it is not possible produce a lightweight metallic bottle that can be sealed with a prior art ROPP closure 10 using the prior art processes and capping apparatus 22. Accordingly, the sideload force applied by the pilfer rollers 28 pressing against the prior art metallic bottle 2 prevents a reduction in the thickness of the metallic bottle 2 (known as “light-weighting”) to form a lighter metallic bottle 2 with a reduced amount of material. Methods and apparatus to seal light-weight metallic bottles are described in applicant's co-pending application published as U.S. Pat. App. Pub. No. 2018/0044155, filed Aug. 12, 2016 and entitled “Apparatus and Methods of Capping Metallic Bottles,” which is incorporated herein in its entirety.

Another disadvantage associated with current ROPP closures 10 which include pilfer bands 18 is a significant expense associated with calibrating and servicing the pilfer rollers 28 of the prior art capping apparatus 22 used to seal the ROPP closures 10 to bottles 2. More specifically, bottlers expend a significant amount of time and expense on setup, calibration, and maintenance of pilfer rollers 28. For example, prior art pilfer rollers 28 require frequent lubrication and periodic replacement of parts including bushings. Further, those of skill in the art will appreciate that proper calibration and setup of pilfer rollers 28 is the most complicated process of preparing a prior art capping apparatus 22 for a production run. This is due to the small production window described above. More specifically, if the pilfer rollers 28 provide too much sideload force, a bottle 2 may fail. In contrast, if the pilfer rollers 28 are not properly calibrated and provide a sideload force that is insufficient, a pilfer band 18 of a ROPP closure 10 may not be completely tucked against the bottle skirt 30 resulting in rejection of a bottle 2 and associated spoilage. Still further, if a pilfer roller 28 is improperly calibrated, the pilfer roller 28 may press into a neck 4 of a bottle 2 below the bottom edge 19 of the pilfer band 18, damaging or reshaping the bottle 2. Improperly calibrated pilfer rollers 28 may also cause wrinkling of pilfer proof bands 18. This can cause a cutting hazard and results in rejection of bottles 2 filled with product.

Another problem with the current method and apparatus of sealing a bottle 2 with a ROPP closure 10 is that by pressing against the bottle 2, the pilfer rollers 28 may exert an excessive force and distort the shape of the bottle 2 and create failure. For example, a cross-sectional shape of the neck portion 4 of the metallic bottle 2 may be deformed from a preferred generally circular shape to a non-circular shape such as an oval or an ellipse. The pilfer rollers 28 also form an unintended groove (not illustrated) in the bottle neck 4 which may decrease the height of the bottle 2, which is known by those of skill in the art as “squatting” the bottle. When the shape of a bottle is distorted by the pilfer rollers 28, the seal between the bottle 2 and a ROPP closure 10 may be defective (or less effective).

Yet another problem with the current ROPP closures 10 is that forming the pilfer band 18 on the closure requires additional forming operations and tooling. More specifically, cuts or slits must be formed in a ROPP closure 10 to produce a serrated band 17. Maintaining and calibrating the tooling required to form the pilfer band 18 increases expenses for the bottler. If the tooling is not properly calibrated or is defective, a ROPP closure 10 may be damaged or the serrated band 17 may be out of specification resulting in rejection or deficient performance of the ROPP closure.

Additionally, an expanded ring or skirt portion 30 must be formed in the bottle 2 to retain a pilfer band 18 of a ROPP closure 10. Forming a skirt portion 30 in a bottle 2 requires die necking the bottle neck 4 inwardly one or more times. The diameter of the neck portion 4 may also be expanded outwardly one or more times when forming the skirt portion 30. As will be appreciated by one of skill in the art, each forming operation is performed by a different apparatus or tool. Thus, there is a significant tooling expense and a large production space requirement associated with forming the skirt portion 30, increasing the production time and associated cost of the bottle 2. These metal shaping procedures may also lead to over-working and excessively weakening the bottle 2 and splitting of the bottle curl 6.

Due to the limitations and shortcomings associated with current ROPP closure designs and methods and apparatus used to seal a bottle with current ROPP closures, there is an unmet need for a new tamper evidence device which may be used with a bottle sealed with a ROPP closure and that may be used with a bottle formed with a thinner body and less material (hereinafter “light-weight” bottle).

### SUMMARY OF THE INVENTION

The present invention provides novel ROPP closures, bottles, and tamper evidence devices as well as a novel capping apparatus. The bottle includes a neck portion without a skirt such as provided in prior art bottles. The ROPP closure can be sealed to a bottle without pressing against the bottle. A tamper evidence device can subsequently be applied to a bottle sealed with a ROPP closure. The tamper evidence device is configured to be visibly altered when the ROPP closure is rotated in an opening direction. In one embodiment, the tamper evidence device is damaged when the ROPP closure is rotated in the opening direction. In another embodiment, the ROPP closure cannot be rotated when the tamper evidence device is associated with the bottle. Optionally, the ROPP closure cannot be removed from the bottle if the tamper evidence device is positioned on the bottle.

In one embodiment, the tamper evidence device can releasably interconnect the ROPP closure to the bottle. More specifically, in one embodiment of the present invention, a first portion of the tamper evidence device is interconnected to the ROPP closure and a second portion of the tamper evidence device is interconnected to the bottle.

In another embodiment, the tamper evidence device covers at least a portion of a neck of a bottle and at least some of a body portion of a ROPP closure sealing the bottle. In still another embodiment, the tamper evidence device covers all of the ROPP closure.

The tamper evidence device can comprise a material applied to a portion of the ROPP closure and the neck portion. In one embodiment, tamper evidence device includes at least one tamper bead applied to the ROPP closure and bottle. The tamper bead is formed of one or more of a wax, a plastic, a paint, an adhesive, and a food grade compound. Rotating the ROPP closure in an opening direction visibly alters the material of the tamper bead. In one embodiment, the ROPP closure cannot be rotated without at least damaging the tamper bead.

In another embodiment, the tamper evidence device is at least one pilfer strip. A first end of the pilfer strip is interconnected to a first portion of a bottle and a second portion is interconnected to a portion of a ROPP closure sealing the bottle. Optionally, a second end of the pilfer strip is interconnected to a second portion of the bottle. In one embodiment, the material of the pilfer strip comprises at least one of a paper, a metal, and a plastic. At least a portion of the pilfer strip can be adhesive. The pilfer strip can also include perforations.

In still another embodiment, the tamper evidence device is a pilfer strip which wraps at least partially around a circumference of a bottle and a ROPP closure which seals the bottle. More specifically, the pilfer strip has an upper portion interconnected to the body portion of the ROPP closure and a lower portion interconnected to the bottle. Optionally, the material of the pilfer strip comprises at least one of a paper, a metal, and a plastic. In one embodiment, the pilfer strip can be interconnected to the ROPP closure and the bottle with an adhesive. A portion of the pilfer strip can include perforations such that the pilfer strip is damaged when the ROPP closure is rotated.

In one embodiment, the tamper evidence device is a pilfer wrap. The pilfer wrap is formed of a material which shrinks when applied to a ROPP closure and a bottle. More specifically, in one embodiment, the pilfer wrap shrinks in at least one dimension when exposed to thermal energy. In one embodiment, the pilfer wrap is applied to a ROPP closure and a bottle by a capping apparatus of the present invention. A heat source subsequently generates thermal energy of a predetermined temperature which is applied to the pilfer wrap. In one embodiment, the heat source blows hot air against the pilfer wrap. In another embodiment, the heat source is located down-stream from the capping apparatus. Optionally, the heat source can comprise an oven or heat tunnel through which a sealed bottle with the pilfer wrap is conveyed. The pilfer wrap substantially conforms to an exterior surface of the ROPP closure and to an exterior surface of the bottle. In one embodiment, the pilfer wrap is formed of one or more of a plastic, a paper, and a metal. In another embodiment, the pilfer wrap is a tube of polymer material. For example, the pilfer wrap can be one of a shrinkable polyvinyl chloride (PVC), a glycolized polyester (PETG), and an oriented polystyrene (OPS). In one embodiment, rotating the ROPP closure in the opening direction visibly alters the pilfer wrap. In another embodiment, the ROPP closure cannot be rotated in the opening direction without at least partially removing the pilfer wrap from the bottle.

In one embodiment, the tamper evidence device is at least partially damaged when the ROPP closure is rotated in the opening direction. Optionally, the tamper evidence device can include an area of weakness. The area of weakness is designed to fracture or tear in response to a predetermined amount of force when the ROPP closure is rotated. In one embodiment, the area of weakness is formed by a plurality of apertures or voids in the tamper evidence device. In another embodiment, the area of weakness is a score formed in a surface of the tamper evidence device. Optionally, the area of weakness can be pre-formed on the tamper evidence device or formed after the tamper evidence device is associated with the ROPP closure.

One aspect of the present invention is a ROPP closure with a novel body portion. In one embodiment, the body portion has a length that is shorter than a body portion of a prior art ROPP closure. Accordingly, the ROPP closure of the present invention can be formed with less material than the prior art ROPP closure.

In one embodiment, the ROPP closure includes a curl. The curl can be formed at a lowermost portion of the closure body portion. In another embodiment, the curl is formed on the closure body portion a predetermined distance from the lowermost portion of the closure body. Optionally, a thread roller of a capping apparatus can be configured to reset in response to contact with the closure curl. In this manner, the thread roller returns to an initial position without contacting a bottle sealed by the ROPP closure. More specifically, the closure curl can prevent a thread roller from moving off of the ROPP closure into direct contact with a neck portion of the bottle.

In another embodiment, the body portion has a length that is greater than a body portion of a prior art ROPP closure. The longer length of the body portion prevents or reduces outward flaring of a lowermost portion of the ROPP body portion during formation of closure threads by thread rollers of a capping apparatus. Accordingly, increasing the length of the body portion can reduce the frequency of filled bottles rejected due to ROPP closures with flared body portions compared to bottles sealed with prior art ROPP closures having a body portion of a shorter length. Another benefit of the increased length of the body portion is an increased distance between an end of the closure threads and a lowermost portion of the closure body portion. The increased distance can prevent a thread roller that is improperly calibrated from moving beyond the closure lowermost portion into contact with a neck of a bottle.

An aspect of the present invention is a ROPP closure comprising: (1) a top portion; and (2) a body portion extending from the top portion, the body portion devoid of a pilfer band. In one embodiment, the body portion does not include a serrated band. Accordingly, the ROPP closure can be manufactured in fewer operations and with less equipment and associated expense than prior art ROPP closures which include a pilfer band. More specifically, the ROPP closure of one embodiment of the present invention does not require cutting or slitting operations necessary to form pilfer bands of prior art ROPP closures. Further, ROPP closures of the present invention can be manufactured with a lower defect rate because less operations are performed during their manufacture.

Yet another aspect of the present invention is a bottle with a pilfer groove or annular ring. The annular ring has a predetermined geometry including a depth sufficient to receive an inwardly oriented protrusion of a pilfer overcap. In one embodiment, the bottle is formed of one of a metal, a plastic, and a glass. In another embodiment, the bottle is formed of metal. The annular ring can be formed on the metallic bottle by spin shaping a neck portion of the metallic bottle. In this manner, the annular ring can be formed without expanding the neck portion outwardly or die necking the neck portion inwardly. Optionally, the annular ring can be formed by necking and expanding the neck portion with dies.

In one embodiment, the annular ring can be formed on the metallic bottle in a single operation by a roller. More specifically, the annular ring can be formed by a threading apparatus in conjunction with the forming of threads on the metallic bottle. Apparatus and tools configured to form threads on metallic bottles are described in U.S. Patent Application Publication No. 2014/0263150, U.S. Pat. Nos. 7,905,130, and 5,704,240 which are each incorporated herein by reference in their entireties.

In one embodiment, the threading apparatus includes an inner tool and an outer tool. The inner and outer tools come together squeezing the neck portion of the metallic bottle therebetween. In one embodiment, the outer tool pushes against, and applies a force to, a predetermined portion of the bottle neck portion. The outer tool contacts the neck portion at a planned centerline of the annular ring. In another embodiment, the inner tool contacts and supports an interior surface portion of the neck portion at points spaced above and below the planned centerline of the annular ring. The inner and outer tools can then be rotated around a longitudinal axis of the metallic bottle. As the tools are rotated around the metallic bottle, the shape of the bottle threads and the annular ring are embossed on the metallic bottle. In one embodiment, the metal of the metallic bottle is pinched between the inner and outer tools. The annular ring has a decreased diameter compared to portions of the bottle neck above and below the annular ring.

In another embodiment, the annular ring is formed by a forming apparatus before, or after, the bottle threads are formed. More specifically, the metallic bottle is spun along its longitudinal axis. An exterior tool of the forming apparatus contacts an exterior surface portion of the neck portion proximate to the planned centerline of the annular ring to form the annular ring. Optionally, an interior tool can be positioned within an interior of the metallic bottle. The interior tool provides support to upper and lower points spaced from the planned centerline.

In one embodiment, the pilfer overcap can include an end portion, a skirt extending from the end portion, and the protrusion extending inwardly from an interior surface of the skirt. In one embodiment, the skirt has a shape that is substantially cylindrical. The pilfer overcap can be sized to cover the ROPP closure when the pilfer overcap is positioned on the bottle. In one embodiment, the ROPP closure cannot be rotated while the pilfer overcap is on the bottle. Optionally, the pilfer overcap must be damaged to be removed from the bottle. In one embodiment, the pilfer overcap further comprises a grasping element. The grasping element may be pulled to rip, tear, or otherwise damage the pilfer overcap to remove the pilfer overcap from the bottle. In another embodiment, a plurality of pilfer overcaps are interconnected. In this manner, a plurality of bottles can be packaged or transported together. In one embodiment, six pilfer overcaps are interconnected such that six bottles are grouped with each other.

Yet another aspect of the present invention is a bottle sealed by a ROPP closure of the present invention. The bottle includes, but is not limited to: (1) a closed end portion; (2) a body portion extending upwardly from the closed end portion; (3) a neck extending upwardly from the body portion; (4) threads formed on at least a portion of the neck; (5) an opening positioned on an uppermost portion of the neck; (6) the ROPP closure positioned on the neck and including closure threads engaging the threads of the bottle; and (7) a tamper evidence device applied to the bottle sealed with the ROPP closure. In one embodiment, the bottle further includes an annular ring formed in the neck. In another embodiment, the ROPP closure does not include a pilfer band.

In one embodiment, the tamper evidence device is interconnected to at least a portion of the bottle and the ROPP closure. In one embodiment, the ROPP closure includes a body portion with a decreased length compared to known ROPP closures. Optionally, the closure body portion includes a curl. In one embodiment, the curl is formed proximate to a lowermost portion of the closure body.

In one embodiment, the tamper evidence device comprises one or more of a paper, a metal, a plastic, an adhesive, and a paint. In another embodiment, the tamper evidence device comprises one of a tamper bead, a pilfer strip generally vertically oriented with respect to the bottle, a pilfer strip generally aligned with a diameter of a neck portion of the bottle, a pilfer wrap at least partially shrunk around the ROPP closure, a pilfer wrap adhered to the bottle, and a pilfer overcap. In one embodiment, the pilfer overcap include an inwardly oriented protrusion that engages the annular ring formed in the bottle neck.

In one embodiment, the bottle is formed of one of a metal, a plastic, and a glass. In one embodiment, the bottle is formed of a metal, such as tin coated steel or aluminum. In another embodiment, the bottle is a light-weight metallic bottle comprising less metallic material and less mass than known metallic bottles sealed with prior art ROPP closures. In one embodiment, the metallic bottle comprises a decreased gauge compared to prior art metallic bottles of substantially the same size and shape.

In one embodiment, the bottle is configured to store a pressurized product. In another embodiment, the bottle can store a pressurized product with a maximum internal pressure of up to about 100 pounds per square inch without unintended venting of product from the bottle. In yet another embodiment, the maximum internal pressure is up to about 135 pounds per square inch without failure or blow-off of a ROPP closure of the present invention.

Still another aspect is a bottle sealed by a ROPP closure which requires less torque to open than prior art ROPP closures. In one embodiment, the ROPP closure does not include a pilfer band. More specifically, by eliminating the pilfer band, rotating the ROPP closure in the opening direction generates less friction between the ROPP closure and the bottle compared to prior art ROPP closures that include a pilfer band.

Another aspect of the present invention is a novel apparatus for capping and sealing a bottle having a threaded neck with a novel ROPP closure. The capping apparatus generally includes, but is not limited to: (1) a pressure block ejector to apply a topload to a top portion of the ROPP closure; (2) a thread roller to apply a sideload to an exterior surface of a body portion of the ROPP closure to form closure threads on the body portion; and (3) a tool configured to apply a tamper evidence device to the bottle sealed with the ROPP closure. In one embodiment, a heat source subsequently applies thermal energy to the tamper evidence device. The heat source can be positioned down-stream from the capping apparatus. Optionally, the capping apparatus also includes a cutting tool to form a tear line on the tamper evidence device. In one embodiment, the tear line comprises a plurality of perforations. In another embodiment, the tear line comprises a score formed by the cutting tool.

The thread roller is configured to press a portion of a body portion of the ROPP closure against threads of the bottle to form closure threads. Optionally, the capping apparatus can have two or more thread rollers. In one embodiment, the thread roller is configured to reset in response to contact with a curl of the ROPP closure.

In one embodiment, the capping apparatus does not include a pilfer roller. The capping apparatus applies less force to the bottle than prior art capping apparatus which include pilfer rollers. Accordingly, a capping apparatus of one embodiment of the present invention may be used to seal a bottle formed of metal that has a decreased gauge compared to known metallic bottles. Another benefit of capping apparatus of the present invention is that the capping apparatus require less time for set-up, calibration, and maintenance and include fewer parts subject to wear or which require periodic replacement compared to prior art capping apparatus.

In one embodiment, the tool of the capping apparatus is configured to interconnect at least a portion of the tamper evidence device to the bottle. Optionally, the tool can interconnect another portion of the tamper evidence device to the ROPP closure. The tamper evidence device can comprise one of a tamper bead, a pilfer strip generally vertically oriented with respect to the bottle, a pilfer strip generally aligned with a diameter of a neck portion of the bottle, a pilfer wrap at least partially shrunk around the ROPP closure, a pilfer wrap adhered to the bottle, and a pilfer overcap. In one embodiment, the pilfer overcap includes a body portion with an inwardly oriented protrusion. The protrusion is configured to be received in an annular ring formed on neck of the bottle.

One aspect of the present invention is to provide a threaded container adapted to receive a ROPP closure. The threaded container generally includes, but is not limited to: (1) a closed end portion; (2) a body portion extending upwardly from the closed end portion; (3) a neck with a decreased diameter extending upwardly from the body portion; (4) threads formed on at least a portion of the neck; and (5) an opening positioned on an uppermost portion of the neck. In one embodiment, the threaded container is formed of one of a plastic, a metal, and a glass. In a more preferred embodiment, the threaded container is formed of a metal. In another embodiment, the threaded container is formed of one of aluminum and tin coated steel.

In one embodiment, the neck does not include a skirt such as are included in prior art threaded containers. Accordingly, in one embodiment, fewer forming operations are required to produce the threaded container. In one embodiment, the threaded container is formed of metal of a thinner gauge compared to prior art threaded containers adapted to be sealed with ROPP closures. More specifically, in one embodiment, at least a portion of the threaded container has a thickness that is approximately 95% of the thickness of a corresponding portion of a prior art metallic bottle formed of the same material. In one embodiment, the threaded container is configured to withstand less of a sideload force (and will fail after receiving less of a sideload force) during capping than a prior art threaded container.

The threaded container can optionally further include an annular ring formed in the neck portion. In one embodiment, the annular ring is spun onto the threaded container. In another embodiment, the annular ring is formed without die necking the neck inwardly or expanding the neck outwardly. Optionally, the annular ring is positioned at the lowermost portion of the threads.

In one embodiment, the annular ring has a depth of at least about 0.03 inches. In another embodiment, the depth is at least about 0.045 inches. In another embodiment, the depth is at least about 0.05 inches. In one embodiment, the depth is less than about 0.3 inches. Accordingly, the depth may be between about 0.03 inches and about 0.3 inches. Optionally, the depth of the annular ring can be related to a diameter of the neck portion of the threaded container. Accordingly, for a threaded container with a first diameter the depth is at least about 0.04 inches and for a second threaded container with a second diameter, the depth is at least about 0.05 inches. In another embodiment, the annular ring has a cross-sectional geometric profile. In one embodiment, the cross-sectional geometric profile of the annular ring is at least one of a U-shape, a V-shape, and an open box with three sides that are generally perpendicular.

In one embodiment, the ROPP closure generally includes: (a) a closed end-wall; (b) a body portion extending downwardly from the closed end-wall; and (c) closure threads formed in a portion of the body portion. Optionally, a curl can be formed on the body portion. In one embodiment, the curl is formed proximate to a lowermost portion of the closure body portion. Additionally, the body portion may be devoid of a pilfer band.

It is another aspect of the present invention to provide a method of sealing a bottle with a Roll-on Pilfer Proof (ROPP) closure. The method generally comprises: (1) positioning the ROPP closure on the bottle, the bottle having: (a) a closed end portion; (b) a body portion extending upwardly from the closed end portion; (c) a neck extending upwardly from the body portion; (d) threads formed on at least a portion of the neck; and (e) an opening positioned on an uppermost portion of the neck; (2) pressing the ROPP closure downwardly against the uppermost portion of the neck; (3) forming threads in a portion a body of the ROPP closure; and (4) applying a tamper evidence device which contacts at least a portion of the bottle. In one embodiment, the bottle is formed of one of a plastic, a metal, and a glass. In another embodiment, the bottle is formed of a metal. In another embodiment, the bottle is formed of one of aluminum and tin coated steel.

In one embodiment, the closure threads are formed by a thread roller of a capping apparatus. In another embodiment, the ROPP closure includes a curl formed on the body portion. Optionally, the thread roller can reset upon contact with the closure curl.

In one embodiment, the tamper evidence device contacts at least a portion of the ROPP closure. In another embodiment, the tamper evidence device is interconnected to portions of the ROPP closure and the bottle. The tamper evidence device can comprise one of: (A) a tamper bead; (B) a pilfer strip generally vertically oriented with respect to the bottle; (C) a pilfer strip generally aligned with a diameter of a neck portion of the bottle; (D) a pilfer wrap at least partially shrunk around the ROPP closure; (E) a pilfer wrap adhered to the bottle; and (F) a pilfer overcap.

In one embodiment, the method further comprises applying thermal energy to the pilfer wrap. The thermal energy causes the pilfer wrap to shrink in at least one dimension. Optionally, in another embodiment, the method includes forming a tear line on the tamper evidence device. In one embodiment, the tear line is formed by a cutting tool of a capping apparatus. The tear line may be formed after the tamper evidence device is applied to the bottle. The tear line may comprise one or more of a score in the tamper evidence device and a plurality of perforations formed through the tamper evidence device.

Although generally referred to herein as a “bottle,” “beverage bottle,” “metallic beverage bottle,” “metallic container,” “beverage container,” “aluminum bottle,” “can,” and “container,” it should be appreciated that the methods and apparatus described herein may be used with containers of any size or shape and that are formed of any material, including, but not limited to metal, plastic, and glass containers including, without limitation, beverage cans and beverage bottles. Accordingly, the term “container” is intended to cover containers of any type and formed of any material that are subsequently sealed with a Roll-on Pilfer Proof (ROPP) closure. Further, as will be appreciated by one of skill in the art, the methods and apparatus of the present invention may be used for any type of threaded container and are not specifically limited to a beverage container such as a soft drink or beer can.

As used herein, the phrase “light-weight metallic bottle” refers to a metallic bottle formed of a reduced amount of metal material than prior art metallic bottles. Accordingly, light-weight metallic bottles have a reduced material thickness in one or more predetermined portions of the metallic bottle compared to prior art metallic bottles. In some embodiments, the light-weight metallic bottle is both thinner (i.e., less gauge) and has less mass than prior art metallic bottles. In one embodiment, at least a portion of the metallic bottle has a thickness that is approximately 95% of the thickness of a corresponding portion of a prior art metallic bottle formed of the same material. One of skill in the art will appreciate that a light-weight metallic bottle formed of even slightly less material compared to a prior art metallic bottle will save manufacturers, bottlers, and shippers money.

The terms “metal” or “metallic” as used hereinto refer to any metallic material that may be used to form a container, including without limitation aluminum, steel, tin, and any combination thereof. However, it will be appreciated that the apparatus and methods of the present invention may be used with threaded containers formed of any material, including paper, plastic, and glass.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

Unless otherwise indicated, all numbers expressing quantities, dimensions, conditions, and so forth used in the specification and claims are to be understood as being modified in all instances by the term “about.”

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials, or acts and the equivalents thereof shall include all those described in the Summary of the Invention, Brief Description of the Drawings, Detailed Description, Abstract, and Claims themselves.

The Summary of the Invention is neither intended, nor should it be construed, as being representative of the full extent and scope of the present invention. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description and no limitation as to the scope of the present invention is intended by either the inclusion or non-inclusion of elements or components. Additional aspects of the present invention will become more readily apparent from the Detailed Description, particularly when taken together with the drawings.

### BRIEF DESCRIPTION OF THE DRAWINGS

The accompanying drawings, which are incorporated herein and constitute a part of the specification, illustrate embodiments of the invention and together with the Summary of the Invention given above and the Detailed Description given below serve to explain the principles of these embodiments. In certain instances, details that are not necessary for an understanding of the disclosure or that render other details difficult to perceive may have been omitted. It should be understood, of course, that the present invention is not necessarily limited to the particular embodiments illustrated herein. Additionally, it should be understood that the drawings are not necessarily to scale.

FIGS. 1A-1D illustrate a method of sealing a metallic bottle with a ROPP closure using a prior art capping apparatus;

FIG. 1E is a partial cross-sectional front elevation view of a portion of a prior art metallic bottle before the metallic bottle is sealed with a ROPP closure;

FIG. 1F is another partial cross-sectional front elevation view of the prior art metallic bottle of FIG. 1E after the metallic bottle has been sealed with a prior art ROPP closure;

FIG. 2 is a partial cross-sectional front elevation view of a portion of a bottle of one embodiment of the present invention before the bottle is sealed with a ROPP closure of the present invention;

FIG. 3 illustrates a capping apparatus of the present invention sealing the bottle of FIG. 2 with a ROPP closure according to one embodiment of the present invention, wherein the ROPP closure has a body of a first length;

FIG. 4 is a partial cross-sectional front elevation view of the bottle of FIG. 2 sealed by a ROPP closure of another embodiment of the present invention which includes a body with a second length;

FIG. 5 illustrates a ROPP closure with a curl sealing a bottle according to another embodiment of the present invention;

FIG. 6 is another partial cross-sectional front elevation view illustrating a tamper bead affixed to a ROPP closure and a bottle of the present invention;

FIG. 7A is a top plan view of a pilfer strip of the present invention;

FIG. 7B is a partial cross-sectional front elevation view of the pilfer strip of FIG. 7A affixed to a bottle sealed with a ROPP closure according to one embodiment of the present invention;

FIG. 8A is a top plan view of another embodiment of a pilfer strip of the present invention;

FIG. 8B is a partial cross-sectional front elevation view of the pilfer strip of FIG. 8A affixed to a ROPP closure sealed to a bottle;

FIG. 9A is a top plan view of a pilfer wrap of one embodiment of the present invention;

FIG. 9B is a front perspective view of a pilfer wrap of another embodiment;

FIG. 9C is a partial cross-sectional front elevation view of the pilfer wrap of FIGS. 9A, 9B positioned on a bottle sealed with a ROPP closure;

FIG. 10 is a partial cross-sectional front elevation view of a pilfer wrap of another embodiment of the present invention affixed to a ROPP closure and a bottle;

FIG. 11 is a partial cross-sectional front elevation view of a portion of a bottle of one embodiment of the present invention which includes an annular ring formed in the bottle neck;

FIGS. 12-14 are partial cross-sectional front elevation views of a portion of another bottle and illustrating tooling used to form an annular ring in the neck portion of the bottle according to one embodiment of the present invention; and

FIGS. 15A-15B are views of a pilfer overcap of one embodiment of the present invention; and

FIG. 16 is a partial cross-sectional front elevation view of the pilfer overcap of FIG. 15 interconnected to a bottle.

To assist in the understanding of one embodiment of the present invention the following list of components and associated numbering found in the drawings is provided herein:

| Number | Component |
|---|---|
| 2 | Bottle of the prior art |
| 4 | Neck portion |
| 6 | Curl |
| 8 | Bottle threads |
| 9 | ROPP shell |
| 10 | ROPP closure |
| 12 | Body portion of ROPP closure |
| 14 | ROPP liner |
| 16 | Closure threads |
| 17 | Serrated band |
| 18 | Pilfer band |
| 19 | Bottom edge of pilfer band |
| 20 | Top portion of ROPP closure |
| 22 | Prior art capping apparatus |
| 24 | Pressure block ejector |
| 25 | Pressure block |
| 26 | Thread roller |
| 28 | Pilfer roller |
| 30 | Skirt of metallic bottle |
| 32 | Channel of closure |
| 36 | Bottle |
| 38 | Neck portion |
| 38A | Neck portion above annular ring |
| 38B | Neck portion below annular ring |
| 40 | Threads |
| 42 | Curl |
| 44 | Annular ring of bottle |
| 48 | Capping apparatus |
| 50 | Pressure block ejector |
| 52 | Pressure block |
| 54 | Thread roller |
| 56A | Exterior roller |
| 56B | Interior roller |
| 56C | Interior roller |
| 58 | ROPP closure |
| 60 | Closed end-wall |
| 62 | Body portion |
| 64 | Closure threads |
| 66 | End of closure threads |
| 68 | Lowermost portion of body |
| 70 | Length of body portion |
| 72 | Curl |
| 74 | Tamper evidence device |
| 76 | Tamper bead |
| 78 | Pilfer strip |
| 80 | Perforations |
| 82 | First narrow end |
| 84 | Second narrow end |
| 86 | Pilfer strip |
| 88 | Long ends |
| 90 | Tear line |
| 92 | Pilfer wrap |
| 94 | Long ends |
| 95 | Ends |
| 96 | Tear line |
| 98 | Pilfer wrap |
| 100 | Pilfer overcap |
| 102 | Closed end-wall |
| 104 | Sidewall |
| 106 | Protrusion |
| 108 | Grasping element |
| 110 | Aperture of grasping element |
| 112 | Tear panel |
| 114 | Score |

### DETAILED DESCRIPTION

The present invention has significant benefits across a broad spectrum of endeavors. It is the Applicant's intent that this specification and the claims appended hereto be accorded a breadth in keeping with the scope and spirit of the invention being disclosed despite what might appear to be limiting language imposed by the requirements of referring to the specific examples disclosed. To acquaint persons skilled in the pertinent arts most closely related to the present invention, a preferred embodiment that illustrates the best mode now contemplated for putting the invention into practice is described herein by, and with reference to, the annexed drawings that form a part of the specification. The exemplary embodiment is described in detail without attempting to describe all of the various forms and modifications in which the invention might be embodied. As such, the embodiments described herein are illustrative, and as will become apparent to those skilled in the arts, may be modified in numerous ways within the scope and spirit of the invention.

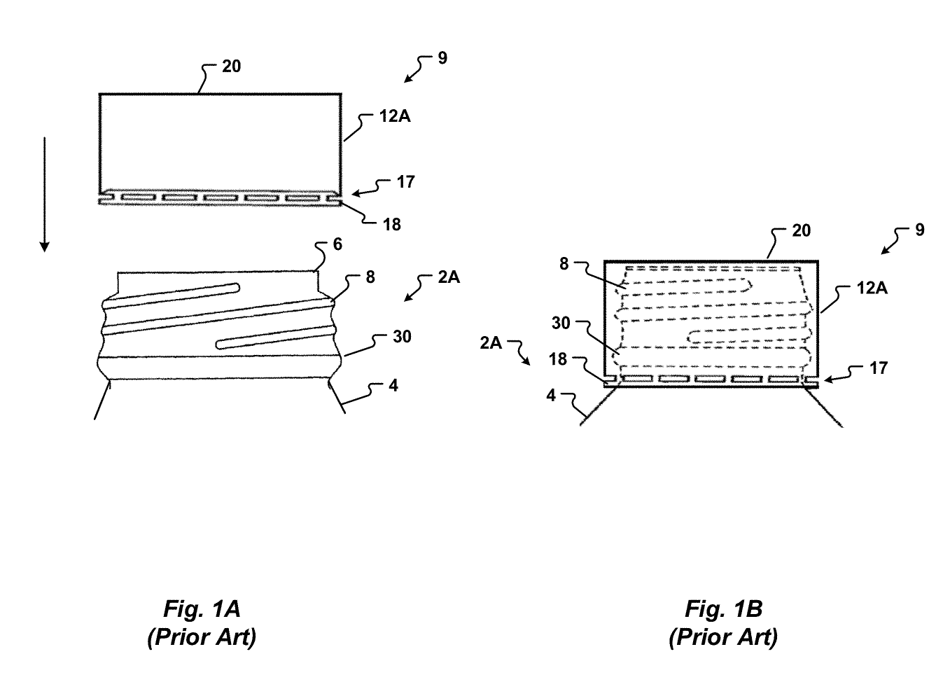

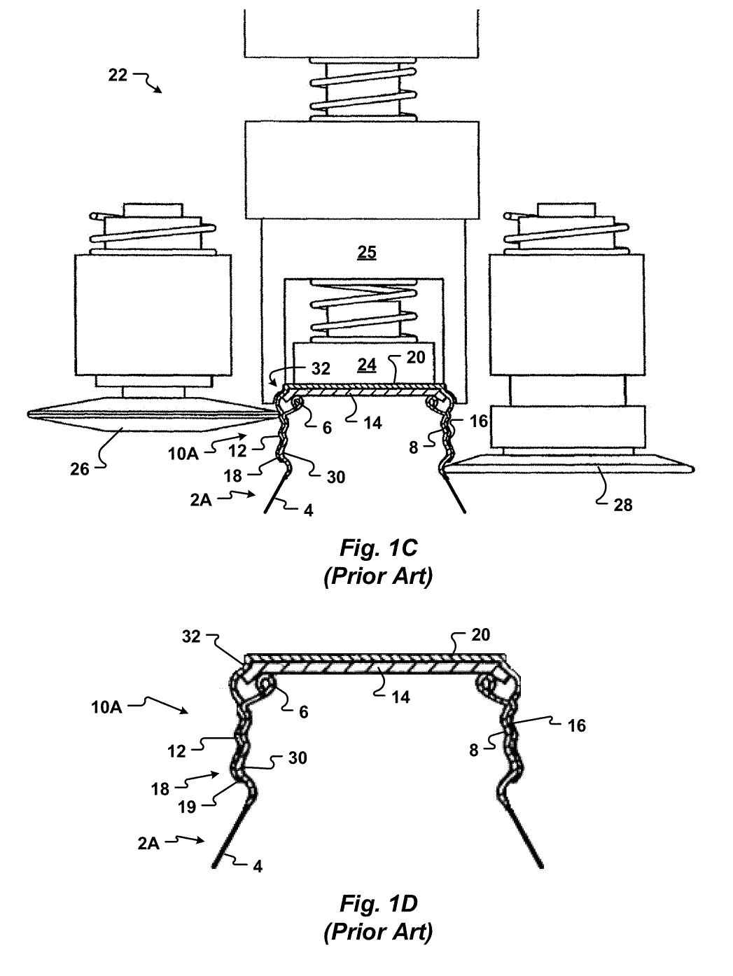

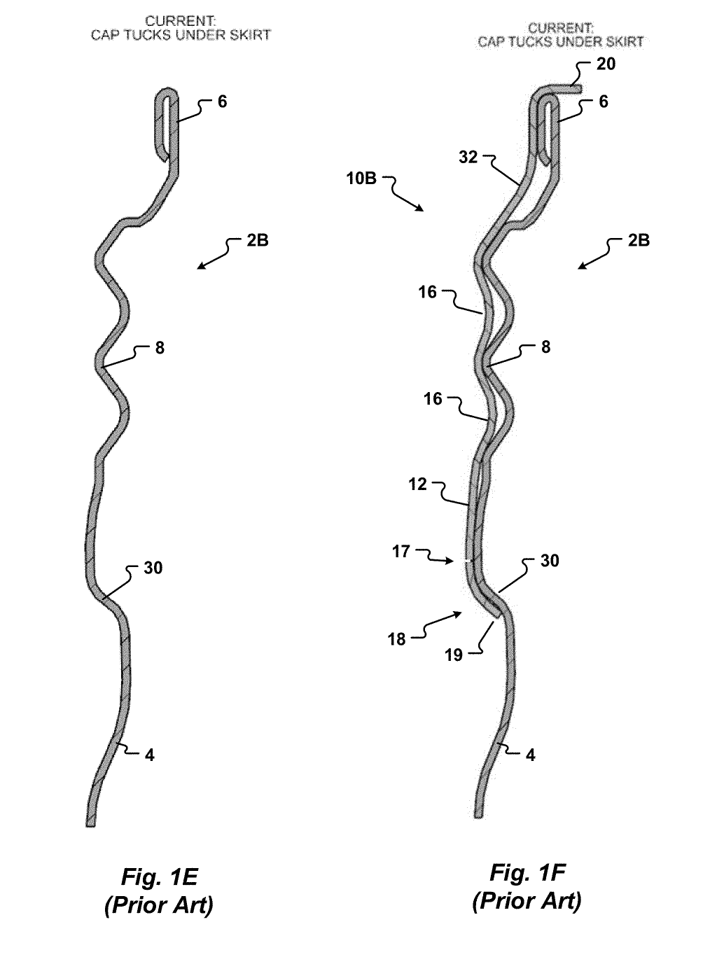

Referring now to FIGS. 1A-1F, a prior art method of sealing a ROPP closure 10 on a threaded neck of a metallic bottle 2 is provided.

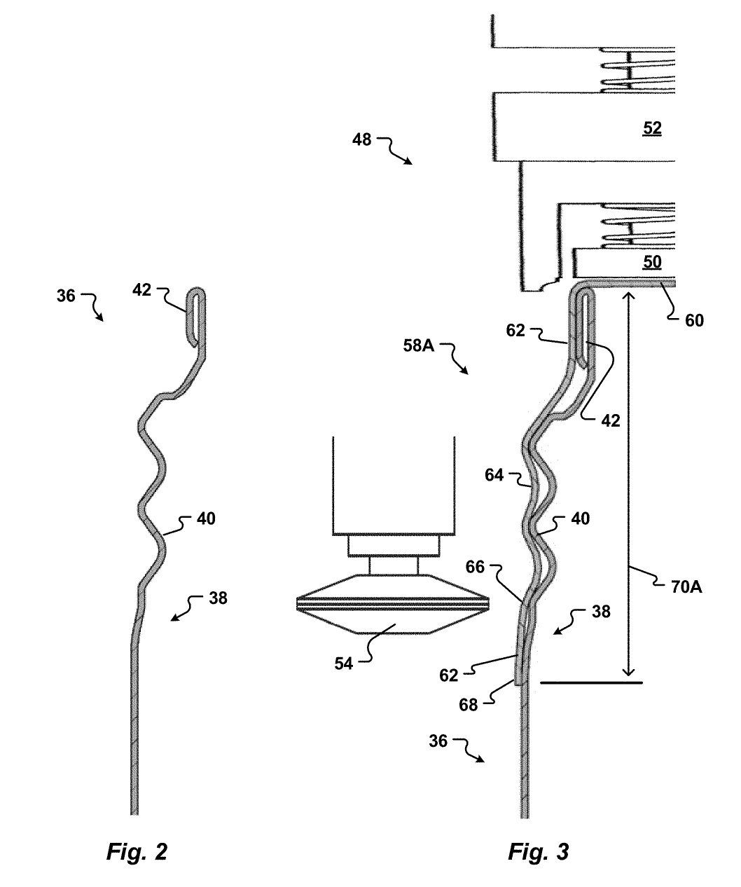

Referring now to FIG. 2, a threaded neck portion 38 of a bottle 36 of one embodiment of the present invention is illustrated. The bottle 36 may be formed of one of a metal, a plastic, and a glass. In one embodiment, the bottle 36 is formed of a metal. In another embodiment, bottle 36 is formed of a metal with a decreased gauge compared to the prior art bottle 2.

The bottle 36 generally includes a neck portion 38 with threads 40 and a curl 42 formed at an uppermost portion of the neck portion proximate to an opening. In one embodiment, the bottle 36 does not include a skirt such as the skirt 30 of the prior art bottle 2. Accordingly, the bottle 36 may be manufactured in fewer operations, and with less tooling, saving time and expense. Further, the metal material of bottle 36 is less likely to fail due to metal fatigue or overwork during manufacture compared to bottle 2 because the operations and metal work required to form skirt 30 are not performed.

Referring now to FIG. 3, a capping apparatus 48 of one embodiment of the present invention is generally illustrated after sealing a ROPP closure 58A to a bottle 36 according to one embodiment of the present invention. The capping apparatus 48 is similar to the capping apparatus 22 of the prior art and generally includes a pressure block ejector 50, a pressure block 52, and a thread roller 54. Notably, in one embodiment, the capping apparatus 48 includes less tooling and requires less time and expense to set-up and service than capping apparatus 22. More specifically, in one embodiment, capping apparatus 48 does not include a pilfer roller 28.

The ROPP closure 58A generally includes a closed end-wall 60, a body portion 62 extending downwardly from the closed end-wall, and closure threads 64 formed on at least a portion of the body portion. When positioned on the bottle 36, the body portion 62 extends beyond the lowest portion of the bottle threads 40. In one embodiment, the ROPP closure 58A does not include the serrated band 17 or the pilfer band 18 of the prior art ROPP closure 10. Accordingly, fewer operations and less tooling is required to form the ROPP closure 58A of the present invention.

In one embodiment, the closure body portion 62 has a length 70A that is less than a length of the body portion 12 of a prior art ROPP closure 10. Accordingly, a ROPP closure 58A of the present invention may be formed of less material than a ROPP closure 10 of the prior art, saving material expenses.

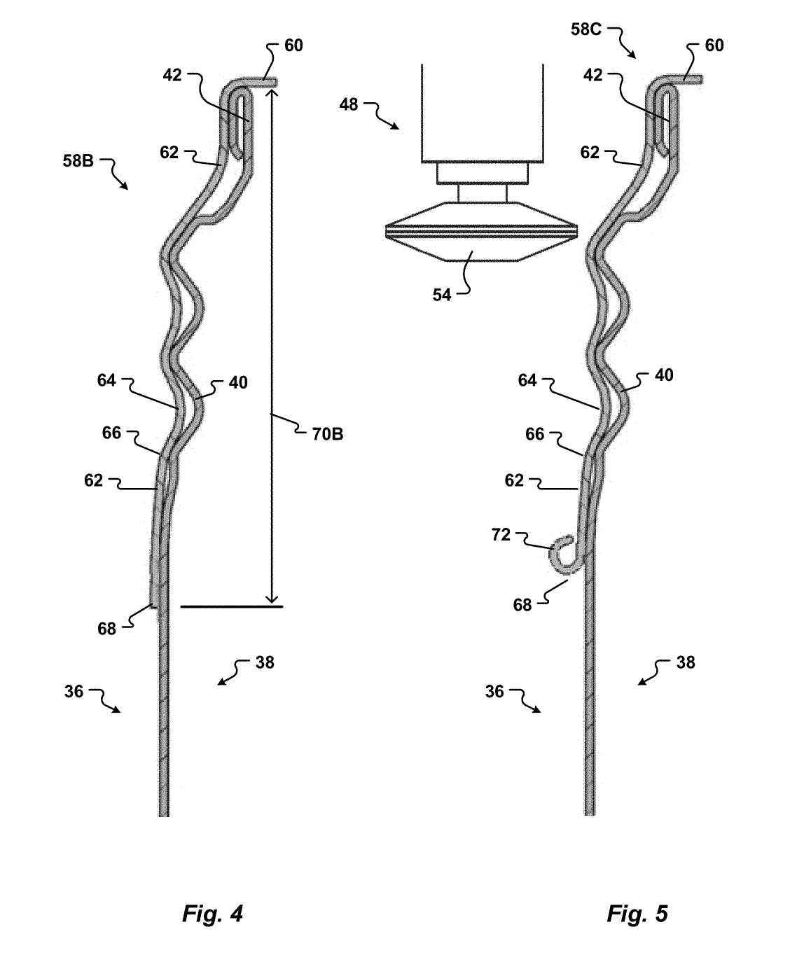

Referring now to FIG. 4, a ROPP closure 58B of another embodiment of the present invention is generally illustrated. The ROPP closure 58B is similar to the ROPP closure 58A illustrated in FIG. 3; however, optionally, the ROPP closure 58B has a body portion 62 with a length 70B that is greater than the length 70A. The longer body portion may prevent, or reduce, flaring of a lowermost portion 68 of the body portion 62 away from the bottle neck 38. More specifically, in some instances, the lowermost portion 68 may bend outwardly during formation of the closure threads 64 by a thread roller 54. When the lowermost portion 68 flares outwardly, a gap may be formed between the bottle neck 38 and a ROPP closure 58. A body portion 62 with an increased length, such as of ROPP closure 58B, increases a distance between the lowermost portion 68 and an end 66 of closure threads 64 reducing the frequency at which the lowermost portion flares outwardly during closure thread formation. The body portion between the thread end 66 and the lowermost portion 68 of the closure body may also prevent a thread roller 54 from moving beyond the lowermost portion 68 into contact with the bottle neck 38. More specifically, the separation between the thread end 66 and the lowermost portion 68 provides more distance for the thread roller 54 to reset to a position proximate the bottle curl 42 without contacting the bottle neck 38 proximate to the closure lowermost portion 68.

FIG. 5 generally illustrates another embodiment of a ROPP closure 58C of the present invention. ROPP closure 58 is similar to ROPP closures 58A, 58B illustrated in FIGS. 3-4 and is formed and sealed to a bottle 36 in the same or similar manner. Additionally, ROPP closure 58C includes a curl 72. In one embodiment, the curl 72 can be formed at a lowermost portion 68 of the ROPP closure 58C. However, the curl 72 can be formed at a different portion of the closure body 62. Accordingly, in another embodiment, the curl 72 is spaced from the closure lowermost portion 68.

In one embodiment, the curl 72 prevents a thread roller 54 of a capping apparatus 48 from moving beyond the lowermost portion 68. In this manner, the curl 72 prevents damage to the bottle 36 caused by a force received from a thread roller 54. In one embodiment, when the thread roller 54 contacts the curl 72 after forming closure threads 64, the thread roller 54 resets and returns to a position proximate to the bottle curl 42 as generally illustrated in FIG. 5.

The closure curl 72 also prevents outward flaring of the closure body portion 62 away from the bottle neck 38. More specifically, the curl 72 makes at least the lowermost portion 68 more rigid.

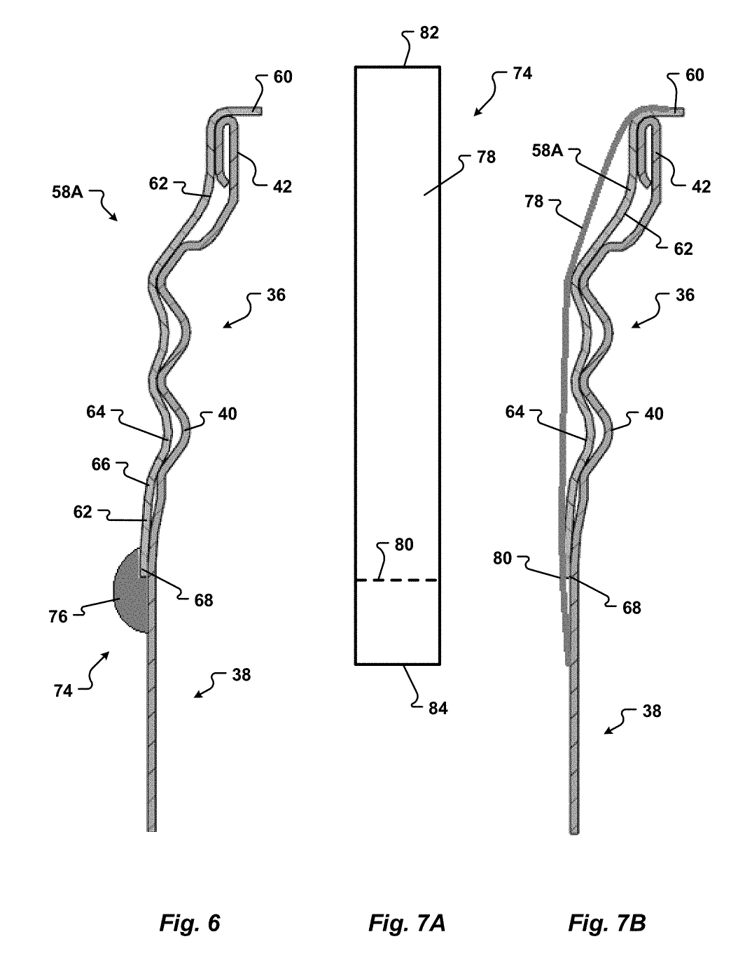

Referring now to FIG. 6, a bottle 36 sealed with a ROPP closure 58 can optionally include a tamper evidence device 74. In one embodiment, the tamper evidence device 74 comprises a tamper bead 76. The tamper bead 76 interconnects the ROPP closure 58 to the bottle neck 38. More specifically, at least a portion of the tamper bead 76 is interconnected to the ROPP closure 58 and another portion of the tamper bead is interconnected to the bottle 36. In one embodiment, the ROPP closure 58 cannot be rotated in an opening direction without one or more of visibly alerting or damaging the tamper bead 76. Although FIG. 6 illustrates a ROPP closure 58A with a short body portion 62 sealing the bottle 36, one of skill in the art will appreciate that the tamper bead 76 of the present invention can also be used with a ROPP closure 58B with a longer body portion or a ROPP closure 58C with a curl 72.

In one embodiment, the tamper bead 76 extends substantially continuously around a circumference of the bottle 36 and the ROPP closure 58. In another embodiment, the tamper evidence device 74 comprises a plurality of tamper beads 76 spaced around the circumference. More specifically, a plurality of tamper beads 76 can be applied to the ROPP closure 58 and bottle 36 with void spaces between adjacent tamper beads.

The tamper bead 76 can be formed of at least one of a wax, a glue, a plastic, a paint, and a varnish. Optionally, in another embodiment, the tamper bead 76 is formed of a food grade compound.

In one embodiment, a capping apparatus 48 of the present invention can apply the tamper bead 76 to the bottle 36 and ROPP closure 58. In another embodiment, the capping apparatus 48 applies the tamper bead 76 after forming the closure threads 64. In still another embodiment, the tamper bead 76 is applied to the bottle 36 and ROPP closure 58 by equipment downstream from the capping apparatus 48.

Referring now to FIG. 7A, a tamper evidence device 74 comprising a pilfer strip 78 is generally illustrated. The pilfer strip 78 can be affixed to a bottle 36 sealed with a ROPP closure 58 as generally illustrated in FIG. 7B.

The pilfer strip 78 generally has a length that is greater than a width. In one embodiment, the length is at least sufficient such that the pilfer strip 78 can be interconnected to a portion of the bottle neck 38 and to a portion of the closed end-wall 60 of the ROPP closure 58. The pilfer strip 78 is optionally formed of at least one of a paper, a plastic, and a metal.

The pilfer strip 78 can optionally include a tear line 80. The tear line can comprise a plurality of perforations. The perforations 80 may be configured to cause the pilfer strip 78 to tear in response to a torque received when the ROPP closure 58 is rotated at least partially in an opening direction. Optionally, the perforations 80 may be formed in a position to be proximate to the lowermost portion 68 of the ROPP closure when the pilfer strip 78 is interconnected to the ROPP closure and bottle. In one embodiment, the perforations 80 are formed generally parallel to the width of the pilfer strip, the width defined by narrow ends 82, 84. In another embodiment, the perforations 80 are formed closer to a second narrow end 84 than to a first narrow end 82.

After closure threads 64 are formed on a ROPP closure 58, the pilfer strip 78 can be interconnected to a bottle 36 and to the ROPP closure 58. At least a portion of the pilfer strip 78 is generally vertically oriented with respect to the bottle 36. In one embodiment, an adhesive is applied to one or more of the bottle 36, the ROPP closure 58, and the pilfer strip 78 to affix the pilfer strip to the ROPP closure and bottle. Optionally, a surface of the pilfer strip 78 may include an adhesive such that the pilfer strip is interconnected to the ROPP closure and bottle without application of a separate adhesive. Regardless, the pilfer strip 78 is interconnected to the bottle 36 and the ROPP closure 58 such that the ROPP closure 58 cannot be rotated in an opening direction without one or more of visibly alerting or damaging the pilfer strip 78.

In one embodiment, a first portion of the pilfer strip 78 is interconnected to the bottle 36. A second portion of the pilfer strip 78 is interconnected to the ROPP closure 58. In one embodiment, the second portion is interconnected to a closed end-wall 60 of the ROPP closure 58. Additionally, or alternatively, the pilfer strip 78 can be interconnected to the closure threads 64. In still another embodiment, another portion of the pilfer strip 78 may be interconnected to the bottle 36 at a position generally diametrically opposed to the first portion (not illustrated). More specifically, the pilfer strip 78 may have a length sufficient to extend across the closed end-wall 60 and beyond the ROPP closure 58 to be interconnected to another portion of the bottle 36.

In one embodiment, a capping apparatus 48 can apply a pilfer strip 78 to a bottle 36 and a ROPP closure 58. In one embodiment, the capping apparatus 48 can form the perforations 80 on the pilfer strip 78. More specifically, in one embodiment the capping apparatus 48 includes a cutting tool. The cutting tool may form the perforations 80 before, or after, the capping apparatus applies a pilfer strip 78 to a bottle 36 sealed with a ROPP closure 58. Alternatively, the perforations 80 can be pre-formed in the pilfer strip 78.

In another embodiment, a pilfer strip 78 can be applied by to a bottle and a ROPP closure by equipment downstream from the capping apparatus 48. Although FIG. 7B illustrates a pilfer strip 78 interconnected to a ROPP closure 58A, in another embodiment, the pilfer strip 78 is interconnected to one of ROPP closures 58B, 58C such as illustrated in FIGS. 4-5.

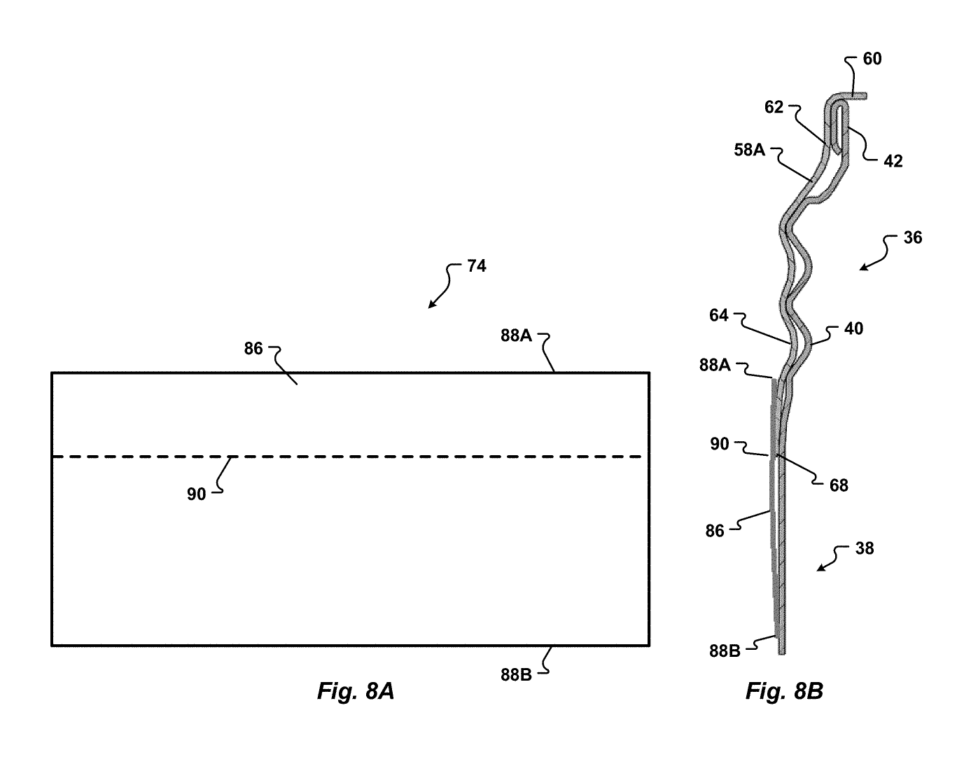

Referring now to FIG. 8A, a tamper evidence device 74 of another embodiment of the present invention is generally illustrated. The tamper evidence device 74 comprises a pilfer strip 86 of another embodiment. The pilfer strip 86 generally has a width defined by a long end 88 that is greater than a height defined by a short end. In one embodiment, the width is greater than a circumference of a neck portion 38 of a bottle 36 to which the pilfer strip 86 will be affixed. Optionally, the pilfer strip 86 can have a shape that is generally rectangular. The pilfer strip 86 may be formed of at least one of a paper, a plastic, and a metal.

In one embodiment, the pilfer strip 86 includes a tear line 90. In one embodiment, the tear line 90 is formed of a plurality of perforations, cuts, or apertures. The tear line 90 can be formed in a portion of the pilfer strip 86 that will be proximate to a lowermost portion 68 of a ROPP closure 58. In one embodiment, the tear line 90 is formed closer to a first long end 88A than to a second long end 88B. In another embodiment, the tear line 90 is formed generally parallel to the first long end 88A.

Referring now to FIG. 8B, a first portion of the pilfer strip 86 is interconnected to a ROPP closure 58. A second portion of the pilfer strip 86 is interconnected to a bottle 36 sealed by the ROPP closure 58. Optionally, the pilfer strip 86 is oriented with the ROPP closure 58 such that the tear line 90 is proximate to the closure lowermost portion 68.

In one embodiment, the pilfer strip 86 is visibly altered when the ROPP closure 58 is rotated at least partially in an opening direction. In another embodiment, the pilfer strip 86 is damaged when the ROPP closure is rotated in the opening direction. For example, in one embodiment, the pilfer strip 86 tears in response to torque received when the ROPP closure is rotated. In one embodiment, the tear line 90 is damaged as the ROPP closure is rotated.

In one embodiment, the pilfer strip 86 can be applied to any ROPP closure 58A-58C of the present invention. Optionally, the pilfer strip 86 can be interconnected to a ROPP closure 58 and a bottle 36 by a capping apparatus 48 of one embodiment of the present invention. In one embodiment, the capping apparatus 48 includes a tool to form the tear line 90 on the pilfer strip 86. In one embodiment, a cutting tool forms the tear line 90. The capping apparatus 48 may form the tear line 90 before, or after, applying a pilfer strip 86 to a bottle 36 and a ROPP closure 58. Alternatively, the tear line 90 may be pre-formed on the pilfer strip.

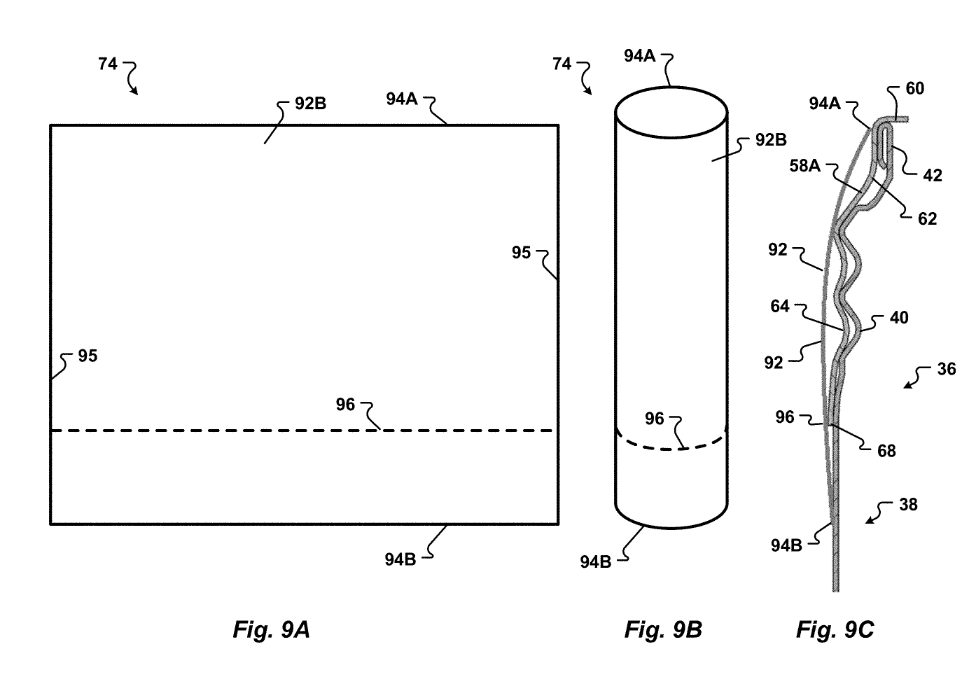

Referring now to FIG. 9A, a tamper evidence device 74 of still another embodiment of the present invention is generally illustrated. The tamper evidence device 74 comprises a pilfer wrap 92. The pilfer wrap 92 has a width at least equal to the circumference of a neck portion 38 of a bottle 36 to which the pilfer wrap will be applied. The width is defined by long ends 94. The pilfer wrap 92 has a height defined by ends 95 sufficient extend from a portion of the bottle neck 38 beyond at least one thread 64 of the ROPP closure 58. Optionally, the pilfer wrap 92 may include a tear line 96. In one embodiment, the tear line 96 comprises one or more of perforations, cuts, apertures, and a score. Optionally, the tear line 96 may be formed closer to a second long end 94B than to a first long end 94A. In another embodiment, the tear line 96 is generally parallel to at least one of the long ends 94. In one embodiment, the pilfer wrap 92 has a shape that is generally rectangular. In another embodiment, illustrated in FIG. 9B, the pilfer wrap 92 has a shape that is generally cylindrical or tubular.

In one embodiment, the pilfer wrap 92 is formed of a plastic material. In another embodiment, the pilfer wrap 92 is formed of a material that will decrease in at least one dimension in response to a predetermined type of energy. More specifically, in one embodiment, the pilfer wrap 92 is formed of a material selected to decrease in at least the width dimension after the pilfer wrap 92 is applied to a bottle 36 sealed with a ROPP closure 58. In this manner, the pilfer wrap 92 is shrink-fit to the bottle and closure. Optionally, the pilfer wrap 92 comprises one or more of a shrinkable polyvinyl chloride (PVC), a glycolized polyester (PETG), and an oriented polystyrene (OPS).

In one embodiment, the pilfer wrap 92 will decrease in width in response to thermal energy of a predetermined temperature. In another embodiment, a height of the pilfer wrap will also decrease in response to the thermal energy. In still another embodiment, the pilfer wrap 92 will only decrease in width when exposed to the thermal energy.

Referring now to FIG. 9C, the pilfer wrap 92 may be applied to a bottle 36 sealed with a ROPP closure 58. The pilfer wrap 92 is positioned at least partially over a body portion 62 of the ROPP closure 58. In one embodiment, a lower long end 94B of the pilfer wrap 92 extends beyond the closure lowermost portion 68 to a neck portion 38 of the bottle 36. Optionally, an upper long end 94A may extend above a closed end-wall 60 of the ROPP closure.

The pilfer wrap 92 is subsequently shrunk in at least the width dimension such that the pilfer wrap may not be removed from the bottle 36 or the ROPP closure 58. In this manner, the ROPP closure 58 may not be rotated in an opening direction without visible alteration of the pilfer wrap 92. In one embodiment, the tear line 96 fractures or is damaged when the ROPP closure 58 is rotated.

The pilfer wrap 92 may be applied by a capping apparatus 48 of the present invention. More specifically, the capping apparatus 48 may position the pilfer wrap 92 on a bottle 36 and a ROPP closure 58. A heat source can then generate thermal energy of a predetermined temperature to shrink at least the width of the pilfer wrap 92. In one embodiment, the heat source is a heat gun that blows hot air against the pilfer wrap 92. In another embodiment, the head source is a heat lamp or an electrical heating element. Optionally, the bottle 36 with the pilfer wrap 92 is transported through an oven, such as a heat tunnel. As the bottle 36 moves through the oven, the pilfer wrap 92 shrinks around the neck portion 38 of the bottle.

Optionally, the capping apparatus 48 may further include a tool to form the tear line 96. In one embodiment, the tool is operable to cut the pilfer wrap 92 to form the tear line. In one embodiment, the tool creates a score to form the tear line 96. In another embodiment, the tool forms a plurality of perforations through the pilfer wrap to define the tear line 96. In another embodiment, the tear line 96 is pre-formed on the material before it is installed over the ROPP closure 58.

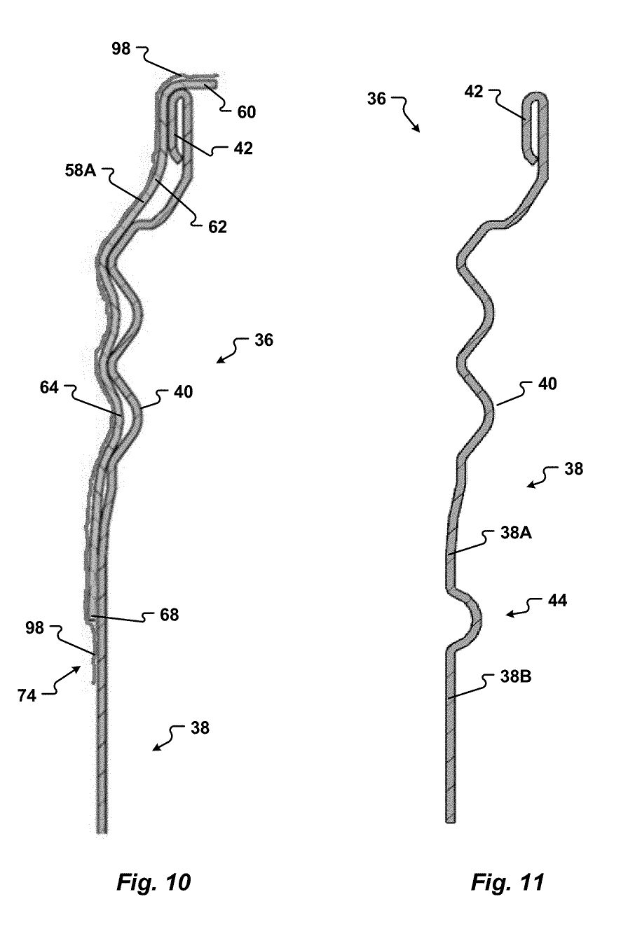

Referring now to FIG. 10, another embodiment of a tamper evidence device 74 is illustrated affixed to a bottle 36 sealed with a ROPP closure 58. The tamper evidence device 74 comprises another pilfer wrap 98 of the present invention. The pilfer wrap 98 is sized and positioned to extend from the bottle neck 38 to at least a portion of the closure body portion 62. In one embodiment, the pilfer wrap 98 covers at least a portion of the closed end-wall 60 of the ROPP closure 58. In another embodiment, when affixed to the bottle 36, the pilfer wrap covers all of the exterior surfaces of the ROPP closure 58. In one embodiment, the pilfer wrap 98 is formed of a material that is thin. Optionally, pilfer wrap 98 may be formed of a metal foil, a paper, and a plastic.

In one embodiment, the pilfer wrap 98 is affixed to at least the bottle 36 with an adhesive. Optionally, the adhesive is applied to at least one of the bottle 36 and ROPP closure 58 before the pilfer wrap 98 is affixed thereto. Alternatively, in another embodiment, the adhesive is applied to a surface of the pilfer wrap 98. Regardless, at least a portion of the pilfer wrap 98 will be altered visibly by rotating the ROPP closure 58 in an opening direction. In one embodiment, at least a portion of the pilfer wrap 98 must be damaged, or removed, from the ROPP closure before the ROPP closure can be rotated.

Referring now to FIG. 11, a bottle 36 of another embodiment of the present invention is generally illustrated. The bottle 36 may be formed of one of a metal, a plastic, and a glass. In one embodiment, the bottle 36 is formed of a metal. The bottle 36 generally includes a neck portion 38 with threads 40 and a curl 42 formed at an uppermost portion of the neck portion proximate to an opening. A groove or annular ring 44 is formed on a portion of the neck 38. The annular ring 44 is positioned on a portion of the neck 38 separate from the bottle threads 40. The position of the annular ring 44 is selected such that the annular ring is not covered by a body portion 62 of a ROPP closure 58 that will seal the bottle. More specifically, the annular ring 44 is spaced from the bottom portion of the bottle threads 40s by a predetermined distance such that the annular ring 44 is below a lowermost portion 68 of a ROPP closure body 64 used to seal the bottle 36.

The annular ring 44 has a predetermined geometry and a predetermined depth. Optionally, the annular ring 44 can have a cross-sectional profile that forms a portion of a circle or of an ellipse; however, as appreciated by one skilled in the art, other geometries can be used. For example, in one embodiment, the annular ring 44 has substantially linear sidewalls and a substantially linear end-wall. In this embodiment, the annular ring 44 has a cross section of three sides of a rectangle. In another embodiment, the annular ring 44 has two substantially linear sidewalls that intersect at an angle. Accordingly, in this embodiment, the annular ring 44 has a generally V-shaped cross section.

The annular ring 44 may have any predetermined depth. In one embodiment, the depth is at least approximately 0.03 inches. In another embodiment, the depth is at least approximately 0.04 inches. In still another embodiment, the depth is at least approximately 0.045 inches. In yet another embodiment, the depth is at least approximately 0.05 inches. Optionally, the depth of the annular ring 44 may be related to a diameter of the neck portion of the metallic bottle 36. Accordingly, for a bottle 36 with a smaller diameter the depth is at least approximately 0.04 inches and for a second bottle with a larger diameter, the depth is at least approximately 0.05 inches. In one embodiment, the depth is less than a depth of a skirt 30 of bottles 2 of the prior art. In another embodiment, the depth is between approximately 0.03 inches and about 0.08 inches.

In one embodiment, a portion of the neck 38A above the annular ring 44 has a diameter that is about equal to a diameter of a portion of the neck 38B below the annular ring 44. Accordingly, in one embodiment of the present invention, the annular ring 44 is formed in a portion of the neck 38 with a substantially uniform diameter. More specifically, the annular ring 44 may be formed in a portion of the neck 38 that is generally parallel to a longitudinal axis of the bottle 36. Thus, in one embodiment, the neck portion 38A is generally parallel to the neck portion 38B.

In one embodiment, when the bottle 36 is formed a metal, the annular ring 44 can be formed by spin shaping the neck portion 38. In this manner, the annular ring 44 can be formed without expanding the neck portion 38 outwardly or die necking the neck portion inwardly. In one embodiment, the annular ring 44 is formed in a single operation by a metal forming tool. In one embodiment, the metal forming tool is a roller.

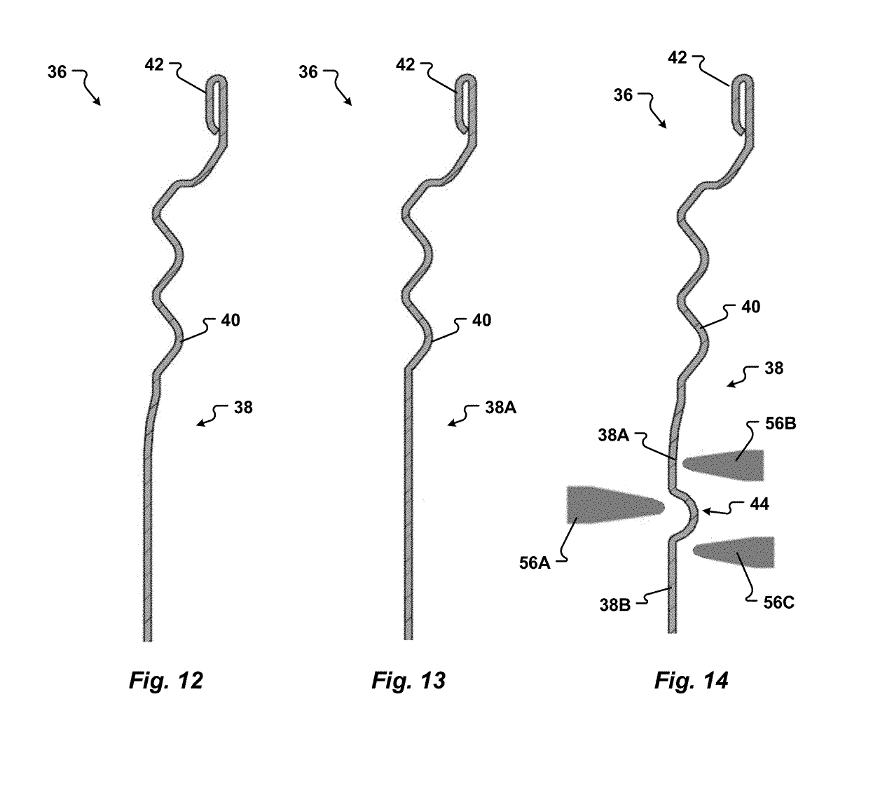

Optionally, in another embodiment, the annular ring 44 can be formed by necking the neck portion 38 of a bottle 36. Spinning tools, such as rollers, are subsequently pressed against predetermined portions of the neck 38. More specifically, and referring now to FIG. 12, after the bottle threads 40 are formed, the neck portion 38 has a first diameter. The neck portion 38A below the bottle threads 40 may be necked to a reduced diameter as generally illustrated in FIG. 13. In one embodiment, the bottle neck 38A of FIG. 13 is about half-way between the first diameter of neck portion 38 of FIG. 12 and an interior diameter of the annular ring 44 to be formed.

Referring now to FIG. 14, rollers 56 then press against predetermined portions of the neck portion 38 to form the annular ring 44. In one embodiment, an exterior roller 56A applies a force to an exterior surface of the neck portion 38 substantially centered on a centerline of the annular ring 44 being formed. Additionally, or alternatively, one or more interior rollers 56B. 56C apply a force to interior surfaces of the neck portion 38 above and below the centerline of the annular ring 44.

As generally illustrated in FIG. 14, an upper portion 38A of the bottle neck has a first diameter, the annular ring 44 has a second diameter, and a lower portion 38B of the bottle neck below the annular ring has a third diameter. In one embodiment, the first and third diameters are approximately equal.

The rollers 56 may be the same as, or similar to, thread rollers 54 of capping apparatus 48. Accordingly, the rollers 56 can be operable to rotate in one or more directions around an axis generally parallel to a longitudinal axis of the metallic bottle 36. Additionally, or alternatively, one or more of the rollers 56 may be operable to rotate around the circumference of the metallic bottle 36 while applying a predetermined force to the neck portion 38. Examples of thread rollers and methods of forming threads on containers are described in U.S. Patent App. Pub. No. 2015/0225107 which is incorporated herein by reference in its entirety.

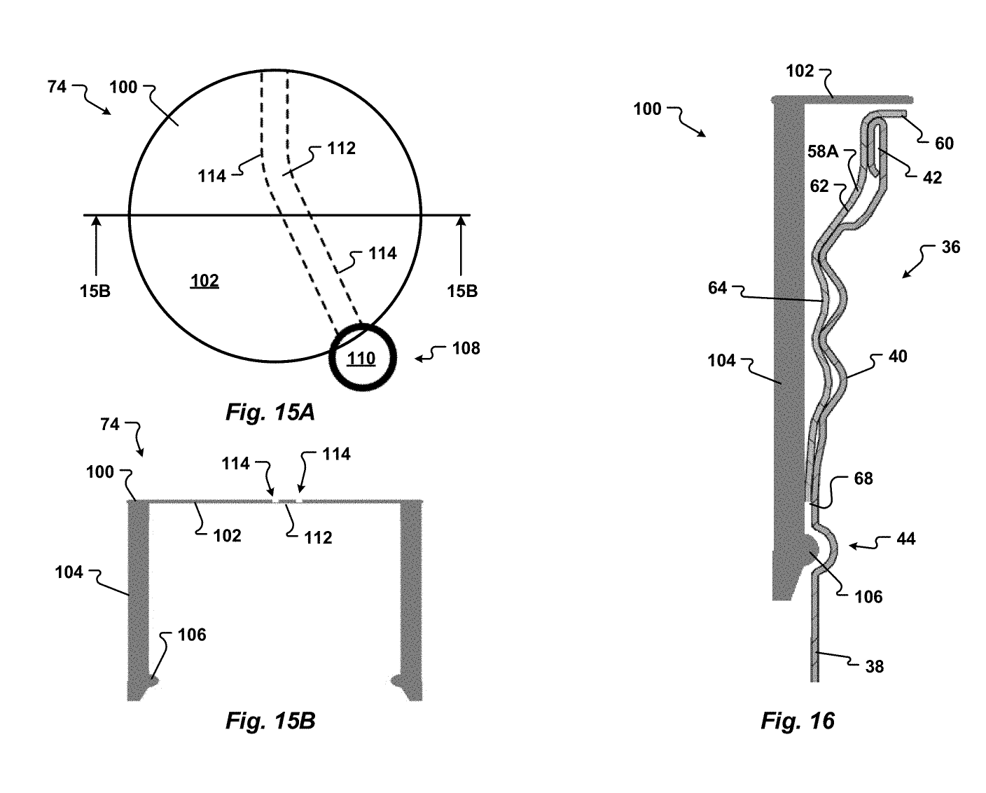

Referring now to FIGS. 15A-15B, a tamper evidence device 74 of another embodiment of the present invention is illustrated. The tamper evidence device 74 is a pilfer overcap 100. The pilfer overcap 100 generally includes a closed end-wall 102, a sidewall 104 extending from the end-wall, and a protrusion 106. The protrusion 106 extends inwardly from the sidewall 104. In one embodiment, the protrusion 106 is oriented to align with an annular ring 44 of a bottle 36 sealed by a ROPP closure 58. In one embodiment, the sidewall 104 has a shape that is generally cylindrical. In one embodiment, the pilfer overcap 100 is made of at least one of a plastic, a metal, and a paper. In another embodiment, the pilfer overcap 100 is rigid.

Optionally, in one embodiment, the pilfer overcap 100 includes a grasping element 108 associated with a tear panel 112. When the tear panel 102 is opened by a force received from the grasping element 108, the pilfer overcap 100 may be removed from a bottle 36 on which it is positioned.

In one embodiment, the tear panel 112 is defined by a portion of the pilfer overcap 100 adapted to sever or tear in response to a force. More specifically, in one embodiment, the tear panel 112 is defined by at least one score 114. The score 114 can comprise a portion of the closed end-wall 102 having a reduced thickness. In another embodiment, the score 114 comprises a plurality of perforations through the closed end-wall 102. Optionally, the tear panel 112 is formed by two scores 114. The size and shape of the tear panel 112 can vary from that depicted in FIG. 15A. In one embodiment, the tear panel 112 extends to at least a portion of the sidewall 104.

The grasping element 108, in one embodiment, is a portion of the tear panel 112 that extends from the pilfer overcap 100. Optionally, the grasping element 108 can have an aperture 110. In another embodiment, the grasping element 108 is interconnected to the tear panel 112. Optionally, the grasping element 108 is a pull tab.

Referring now to FIG. 16, when a pilfer overcap 100 is positioned on a bottle 36 sealed with a ROPP closure 58, a protrusion 106 of the pilfer overcap fits at least partially into the bottle annular ring 44. In one embodiment, the protrusion 106 has a cross-sectional shape that substantially corresponds to a cross-sectional shape of the annular ring 44. Optionally, the cross-sectional shape of the protrusion 106 is generally that of a semi-circle. In another embodiment, contact between the protrusion 106 and the annular ring 44 prevents removal of the pilfer overcap 100 from the bottle 36.

The pilfer overcap 100 is configured to cover at least a portion of the ROPP closure 58. In one embodiment, the pilfer overcap 100 covers at least a body portion 62 of the ROPP closure. In another embodiment, the pilfer overcap 100 covers at least a portion of a closed end-wall 60 of the ROPP closure. In one embodiment, the pilfer overcap 100 covers all of the ROPP closure 58.

In one embodiment, the ROPP closure 58 cannot be rotated in the opening direction while the pilfer overcap 100 is positioned on the bottle 36. In another embodiment, the pilfer overcap 100 prevents removal of the ROPP closure 58 from the bottle 36. In still another embodiment, the pilfer overcap 100 cannot be removed from the bottle 36 without visibly altering the pilfer overcap 100. Accordingly, a user must tear or damage the pilfer overcap 100 to obtain access to the ROPP closure 58.

The pilfer overcap 100 can be sized for use with any ROPP closure 58A, 58B, 58C of the present invention. Accordingly, when a ROPP closure 58C with a curl 72 is used to seal bottle 36, the sidewall 104 may have a greater diameter to accommodate a diameter of the curl 72.

A pilfer overcap 100 may be positioned on a bottle 36 by a capping apparatus 48 of the present invention. More specifically, after a thread roller 54 of the capping apparatus 48 forms closure threads 64 on a ROPP closure 58 to seal the bottle 36, the capping apparatus 48 can position the pilfer overcap 100 on the bottle 36. In one embodiment, the capping apparatus 48 can form a score 114 in the pilfer overcap 100. Accordingly, the capping apparatus 48 may optionally include a cutting tool to form the score 114. In one embodiment, the capping apparatus 48 forms the score 114 after the pilfer overcap 100 is positioned on the bottle 36. In this manner, the pilfer overcap 100 may be positioned on the bottle 36 without inadvertent or unintended alteration or fracture of the score 114. In another embodiment, the score is pre-formed on the pilfer overcap 100 prior to placement of the overcap on a bottle 36. Alternatively, in another embodiment, a pilfer overcap 100 is positioned on a bottle 36 by equipment downstream from the capping apparatus 48.

Optionally, two or more pilfer overcaps 100 can be interconnected. In this manner, the interconnected pilfer overcaps 100 can be used to carry two or more bottles 36. More specifically, two or more pilfer overcaps 100 can be interconnected to form a carrier for two or more bottles 36. In one embodiment, six pilfer overcaps 100 can be joined together such that a six-pack of bottles 36 can be transported together. One of skill in the art will appreciate that any number of pilfer overcaps 100 can be interconnected.

The description of the present invention has been presented for purposes of illustration and description, but is not intended to be exhaustive or limiting of the invention to the form disclosed. Many modifications and variations will be apparent to those of ordinary skill in the art. The embodiments described and shown in the figures were chosen and described in order to best explain the principles of the invention, the practical application, and to enable those of ordinary skill in the art to understand the invention.

While various embodiments of the present invention have been described in detail, it is apparent that modifications and alterations of those embodiments will occur to those skilled in the art. Moreover, references made herein to “the present invention” or aspects thereof should be understood to mean certain embodiments of the present invention and should not necessarily be construed as limiting all embodiments to a particular description. It is to be expressly understood that such modifications and alterations are within the scope and spirit of the present invention, as set forth in the following claims.

What is claimed is:

1. A capping apparatus to seal a bottle having a threaded neck with a ROPP closure, comprising:
a pressure block ejector to apply a topload to a top portion of the ROPP closure;
a thread roller to apply a sideload to an exterior surface of a body portion of the ROPP closure to form closure threads on the body portion; and
a tool configured to apply a tamper evidence device to the bottle sealed with the ROPP closure.

2. The capping apparatus of claim 1, wherein the tamper evidence device comprises one of:
a tamper bead;
a pilfer strip generally vertically oriented with respect to the bottle;
a pilfer strip generally aligned with a diameter of a neck portion of the bottle;
a pilfer wrap at least partially covering the ROPP closure, the pilfer wrap shrinkable in at least a width dimension;
a pilfer wrap adhered to the bottle; and
a pilfer overcap.

3. The capping apparatus of claim 1, further comprising a tool to form a tear line on the tamper evidence device.

4. The capping apparatus of claim 1, wherein the ROPP closure includes a closed end-wall and a body portion with a curl.

5. The capping apparatus of claim 4, wherein the thread roller is configured to move upwardly toward the closed end-wall of the ROPP closure in response to contact with the curl.

6. The capping apparatus of claim 1, wherein the capping apparatus is configured to apply thermal energy to the tamper evidence device.

7. A method of sealing a bottle with a roll-on pilfer proof (ROPP) closure, comprising:
positioning the ROPP closure on the bottle, the bottle having:
a closed end portion;
a body portion extending upwardly from the closed end portion;
a neck extending upwardly from the body portion;
threads formed on at least a portion of the neck; and
an opening positioned on an uppermost portion of the neck;
pressing the ROPP closure downwardly against the uppermost portion of the neck;
forming threads in a portion of a body of the ROPP closure; and
applying a tamper evidence device to the bottle sealed with the ROPP closure.

8. The method of claim 7, wherein the tamper evidence device comprises one of a tamper bead, a pilfer strip generally vertically oriented with respect to the bottle, a pilfer strip generally aligned with a diameter of a neck portion of the bottle, a pilfer wrap to be at least partially shrunk around the ROPP closure, a pilfer wrap adhered to the bottle, and a pilfer overcap.

9. The method of claim 7, further comprising applying thermal energy to the tamper evidence device such that the tamper evidence device shrinks in at least one dimension.

10. A metallic bottle sealed by a ROPP closure, comprising:
a closed end portion;
a body portion extending upwardly from the closed end portion;
a neck extending upwardly from the body portion;
threads formed on at least a portion of the neck;
an opening positioned on an uppermost portion of the neck;
the ROPP closure positioned on the neck and including closure threads engaging the threads of the metallic bottle; and
a tamper evidence device applied to the metallic bottle sealed with the ROPP closure.

11. The metallic bottle of claim 10, wherein the tamper evidence device comprises one of:
a tamper bead;
a pilfer strip generally vertically oriented with respect to the metallic bottle;
a pilfer strip generally aligned with a diameter of a neck portion of the metallic bottle;
a pilfer wrap at least partially shrunk around the ROPP closure;
a pilfer wrap adhered to the metallic bottle; and
a pilfer overcap.

12. The metallic bottle of claim 11, wherein the metallic bottle further includes an annular ring formed in the neck to receive a protrusion extending inwardly from a sidewall of the pilfer overcap.

13. The metallic bottle of claim 10, wherein the ROPP closure includes a body portion with a curl.
